(19) United States
(12) Patent Application Publication
(10) Pub. No.: US 2005/0117632 A1
(43) Pub. Date: Jun. 2, 2005

(54) Mobile terminal for cell searching via an iterative correlation system

(76) Inventor: Yanmeng Sun, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/500,549

(22) PCT Filed: Dec. 9, 2002
(86) PCT No.: PCT/IB02/05348

(30) Foreign Application Priority Data
Jan. 7, 2002 (EP) 02075028.7

(51) Int. Cl. H04B 1/69

(52) U.S. Cl. 375/150

(57) ABSTRACT

Mobile terminals (1) for searching cells identified by code signals in Time Division-Synchronous Code Division Multiple Access (TD-SCDMA) telecommunication systems comprise correlation systems (4) for correlating input signals with stored code signals. The best correlation result defines the code signal used, which identifies the cell. By providing correlation systems (4) with controllers (3) for controlling correlation systems for performing iterative correlations and adapting correlation parameters per iterative correlation, the computational complexity is reduced much. Said correlation parameter corresponds with the length of code signals, which firstly is to be reduced and then per next iteration is to be increased, and/or with the number of code signals, which per next iteration is to be reduced. Said controllers (3) comprise comparators (5) for comparing correlation results for in dependence of comparison results adapting correlation parameters, and selectors (5) for in response to comparison results selecting a reduced number of code signals to be used for next correlations.

The invention relates to a correlation system for correlating an input signal with a number of code signals each having a code length.

The invention also relates to a mobile terminal for searching cells identified by code signals, which mobile terminal comprises a receiver for receiving a radio signal comprising at least one code signal and for converting said radio signal into an input signal and comprises a correlation system coupled to said receiver for correlating said input signal with a number of said code signals each having a code length, and to a method for correlating an input signal with a number of code signals each having a code length, to a processor program product for correlating an input signal with a number of code signals each having a code length, and to a method for searching cells identified by code signals, which method comprises the steps of receiving a radio signal comprising at least one code signal and of converting said radio signal into an input signal and of correlating said input signal with a number of said code signals each having a code length.

Such a correlation system and such a mobile terminal are for example used in Time Division-Synchronous Code Division Multiple Access (TD-SCDMA) telecommunication systems, in which for example thirty-two different cells are identified by cell-unique code signals, each having a length of for example sixty-four chips.

A prior art correlation system is known from US 2001/0021199 A1, publication date Sep. 13, 2001. To find the cell in which the mobile terminal is situated, the receiver in the mobile terminal must receive the radio signal originating from a base station and comprising the code signal identifying this cell, and must convert said radio signal into the input signal. Then the correlation system coupled to said receiver must correlate said input signal with a number (for example thirty-two) of said code signals which each have a code length (for example sixty-four chips) and which each have been previously stored in a terminal's memory. Thereto said correlation system comprises (for example thirty-two) correlators each one for dealing with a particular code signal parallelly, or alternatively for example one correlator deals with all code signals serially. The best correlation result provides a rough/initial synchronization, and defines the code signal used, which identifies the cell.

The known correlation system is disadvantageous, inter alia, due to requiring too much processing capacity. Said code signal (for example comprising sixty-four chips) is sent once per subframe of five msec. (and for example comprising 6048 chips). Then a number (for example thirty-two) of sliding correlations must be performed parallelly, or at most said number (for example thirty-two) of sliding correlations must be performed serially, with each sliding correlation comprising the sliding (chip for chip) of the length (for example sixty-four chips) of a code signal through the entire subframe (for example comprising 6048 chips). Such a computational complexity is extremely high, due to each sliding correlation per chip-sliding comprising one or more calculations.

It is an object of the invention, inter alia, of providing a correlation system as defined in the preamble which requires less processing capacity.

The correlation system according to the invention is characterized in that said correlation system comprises a controller for controlling said correlation system for performing iterative correlations and for adapting at least one correlation parameter per iterative correlation.

By introducing iterative correlations, each one of the (for example thirty-two) correlations is cut into pieces, with each piece requiring less processing capacity, due to having a reduced computational complexity. The results of previous pieces of correlations can be used for next pieces of correlations (thereby for example starting with small pieces which grow per iterative correlation), with these results for example being used for the adaption of said at least one correlation parameter per iterative correlation. This allows iterative correlations to be performed in an optimal way.

The invention is based upon an insight, inter alia, that one big problem, which is difficult to solve, can be cut into many smaller problems, which are easier to solve, and is based upon a basic idea, inter alia, that a number of very precise calculations can be converted into an iteration comprising a number of rough calculations followed by one or more reduced numbers of more precise calculations.

The invention solves the problem, inter alia, of providing a correlation system, which reduces the computational complexity defined above.

A first embodiment of the correlation system according to the invention as defined in claim 2 is advantageous in that a first correlation parameter corresponds with the length of code signals, with first correlations using code signals each having a first length (for example thirty-two chips) smaller than said code length (for example sixty-four chips), and with next correlations using code signals each having a second length (for example forty-eight chips) larger than said first length and smaller than or equal to said code length. By starting with using just for example the first thirty-two chips of each sixty-four chip code signal, the computational complexity is reduced a lot, and the results of the thirty-two correlations each based upon sliding just the first thirty-two chips of each sixty-four chip code signal through the entire subframe of 6048 chips can be used for the next correlations, due to these results already indicating the chances of success. For example when performing all sliding correlations serially, these results can be used for defining a preferential sequence.

A second embodiment of the correlation system according to the invention as defined in claim 3 is advantageous in that a second correlation parameter corresponds with the number of code signals, with first correlations using a first number (for example thirty-two) of code signals, and with next correlations using a second number (for example twelve) of code signals smaller than said first number of code signals. By using the results of the thirty-two correlations, each based upon sliding just the first thirty-two chips of each sixty-four chip code signal through the entire subframe of 6048 chips, for the next correlations such that said first number (for example thirty-two) of code signals is reduced to said second number (for example twelve) of code signals (by selecting in dependence of said results those twelve code signals which are most promising), thereby now sliding the first forty-eight chips of each one of these twelve code signals through the entire subframe of 6048 chips, the computational complexity keeps its lower level.

A third embodiment of the correlation system according to the invention as defined in claim 4 is advantageous in that said controller is coupled to and/or comprises a comparator for comparing correlation results for in dependence of comparison results adapting said at least one correlation parameter. Said comparing may comprise the comparison of correlation results with each other as well as the comparison of correlation results with thresholds which may be made adjustable possibly in dependence of comparison results.

A fourth embodiment of the correlation system according to the invention as defined in claim 5 is advantageous in that said controller is coupled to and/or comprises a selector for in response to comparison results selecting a reduced number of code signals to be used for next correlations. Said selector may select those code signals to be used for next correlations as well as may select the size of the reduction, both generally in dependence of comparison results.

Embodiments of the mobile terminal according to the invention, of the method for correlating according to the invention, of the processor program product according to the invention and of the method for searching cells identified by code signals according to the invention correspond with the embodiments of the correlation system according to the invention.

These and other aspects of the invention will be apparent from and elucidated with reference to the embodiments(s) described hereinafter.

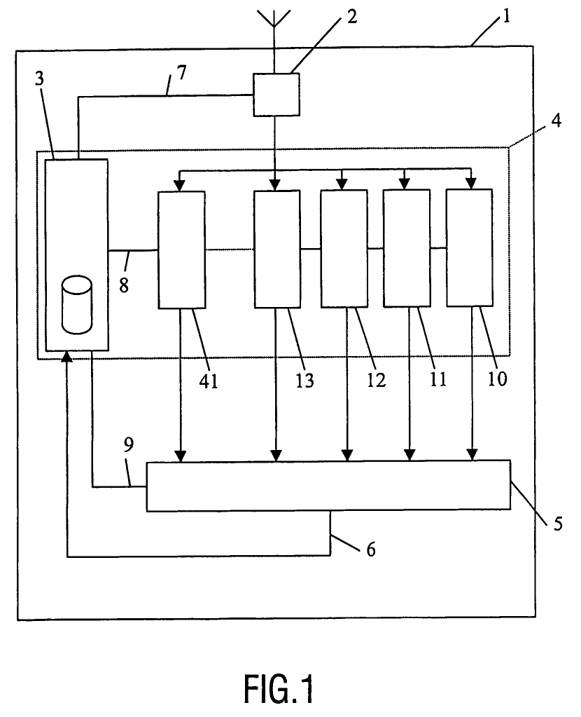

FIG. 1 illustrates in block diagram form a mobile terminal according to the invention comprising a correlator system according to the invention, and

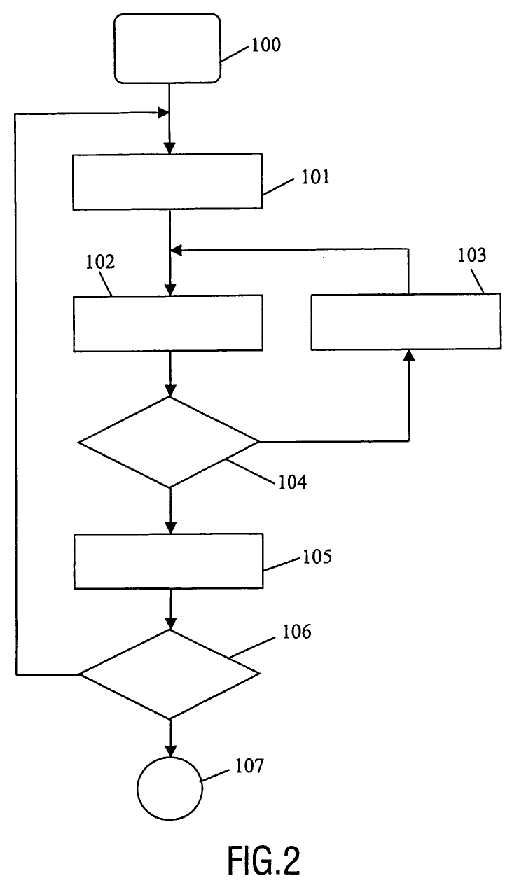

FIG. 2 illustrates a flow chart for elucidating a method according to the invention and a processor program product according to the invention.

FIG. 1 illustrates in block diagram form a mobile terminal 1 comprising a receiver 2 of which an in/output is coupled to an antenna and of which a control in/output is coupled to a control in/output of controller 3 via a control connection 7. An output of receiver 2 is coupled to an input of a correlation system 4. This input of correlation system 4 is coupled to inputs of thirty-two parallel correlators 10-41 each one having a control in/output coupled to a control in/output of controller 3 via a control connection 8, and each one having an output coupled to its own input of a comparator/selector 5. An output of comparator/selector 5 is coupled via a connection 6 to an input of controller 3, of which a control in/output is further coupled to a control in/output of comparator/selector 5 via a control connection 9. Controller 3 for example comprises a processor/memory.

Prior art mobile terminals comprising prior art correlation systems for correlating an input signal with a number of code signals each having a code length are for example used in Time Division-Synchronous Code Division Multiple Access (TD-SCDMA) telecommunication systems, in which for example at most thirty-two different cells are identified by cell-unique code signals, each having a length of for example sixty-four chips. To find the cell in which the mobile terminal is situated, the receiver in the mobile terminal must receive the radio signal originating from a base station and comprising the code signal identifying this cell, and must convert said radio signal into the input signal. Then the correlation system coupled to said receiver must correlate said input signal with a number (for example thirty-two) of said code signals which each have a code length (for example sixty-four chips) and which each have been previously stored in a terminal's memory. Thereto said correlation system comprises (for example thirty-two) correlators each one for dealing with a particular code signal parallelly, or alternatively for example one correlator deals with all code signals serially. The best correlation result defines the code signal used, which identifies the cell. This requires much processing capacity. Said code signal (for example comprising sixty-four chips) is sent once per subframe of five msec. (and for example comprising 6048 chips). Then a number (for example thirty-two) of sliding correlations must be performed parallelly, or at most said number (for example thirty-two) of sliding correlations must be performed serially, with each sliding correlation comprising the sliding (chip for chip) of the length (for example sixty-four chips) of a code signal through the entire subframe (for example comprising 6048 chips). Such a computational complexity is extremely high, due to each sliding correlation per chip-sliding comprising one or more calculations.

The correlation system 4 according to the invention comprises a controller 3 for controlling said correlation system 4 for performing iterative correlations and for adapting at least one correlation parameter per iterative correlation. By introducing iterative correlations, each one of the (for example thirty-two) correlations is cut into pieces, with each piece requiring less processing capacity, due to having a reduced computational complexity. The results of previous pieces of correlations can be used for next pieces of correlations, by for example using these results for the adaption of at least one correlation parameter per iterative correlation. This allows iterative correlations to be performed in an optimal way.

Thereto, controller 3 controls correlators 10-41 in such a way that either each correlator 10-41 uses a first part of its code signal already stored in the correlator's memory or each correlator 10-41 receives from controller 3 via control connection 8 this first part of its code signal already stored in controller 3. The first part of each code signal for example has a first length (for example thirty-two chips) which is smaller than the code length (for example sixty-four chips) of the original code signal (and for example comprises the first thirty-two chips of the sixty-four chips). By starting with using just for example the first thirty-two chips of each sixty-four chip code signal, the computational complexity is reduced a lot, and the results of the thirty-two correlations each based upon sliding just the first thirty-two chips of each sixty-four chip code signal through the entire subframe of 6048 chips can be used for the next correlations, due to these results already indicating the chances of success, as follows.

These results are supplied for each one of said correlator's 10-41 to comparator/selector 5 and for example comprise for each one of said correlator's 10-41 a sequence of digital signals. In response to the receival of these sequences of digital signals, either comparator/selector 5 converts each sequence into one digital number (by for example calculating the energy or the power etc.) and compares these digital numbers with each other and/or with first thresholds, or comparator/selector 5 compares the corresponding digital signals of said sequences with each other and/or with second thresholds, possibly after having made calculations (like for example adding or subtracting values etc.). Then in response to comparison results, comparator/selector 5 selects from all correlators those correlators (or those code signals) which have generated the most promising results (the best correlations). In other words, comparator/selector 5 selects a second number (for example twelve) of correlators (of code signals) from a first number (for example thirty-two) of correlators (of code signals), and informs controller 3 via connection 6.

In response to this selection, controller 3 activates via control connection 8 those (for example twelve) correlators which have been selected by comparator/selector 5, and deactivates the other (for example twenty) correlators. Controller 3 further controls the selected correlators in such a way that either each selected correlator now uses a second part of its code signal already stored in the correlator's memory or each selected correlator receives from controller 3 via control connection 8 this second part of its code signal already stored in controller 3. The second part of each selected code signal for example has a second length (for example forty-eight chips) which is smaller than the code length (for example sixty-four chips) of the original code signal (and for example comprises the first forty-eight chips of the sixty-four chips). By now using for example the first forty-eight chips of each selected sixty-four chip code signal, but just for twelve out of thirty-two correlators (or code signals), these for example first forty-eight chips of each one of the selected for example twelve code signals are slided through the entire subframe of for example 6048 chips, and the computational complexity keeps its lower level.

The selected twelve correlators in response generate results which are supplied for each one of said twelve correlator's to comparator/selector 5 and for example comprise for each one of said twelve correlator's a sequence of digital signals. In response to the receival of these sequences of digital signals, comparator/selector 5 makes its comparisons again, thereby now using third and fourth thresholds which are equal to said first and second thresholds or which are updated versions, and in response selects from said twelve correlators those correlators (or those code signals) which have generated the most promising results (the best correlations). In other words, comparator/selector 5 selects a third number (for example six) of correlators (of code signals) from a second number (for example twelve) of correlators (of code signals), and informs controller 3 via connection 6.

In response to this selection, controller 3 activates via control connection 8 those (for example six) correlators which have been selected by comparator/selector 5, and deactivates the other (for example twenty six) correlators. Controller 3 further controls the selected correlators in such a way that either each selected correlator now uses a third part of its code signal already stored in the correlator's memory or each selected correlator receives from controller 3 via control connection 8 this third part of its code signal already stored in controller 3. The third part of each selected code signal for example has a third length (for example fifty six or sixty-four chips) which is smaller than or equal to the code length (for example sixty-four chips) of the original code signal (and for example comprises the first fifty six or all sixty-four chips of the sixty-four chips). By now using for example the first fifty six or sixty-four chips of each selected sixty-four chip code signal, but just for six out of thirty-two correlators (or code signals), these for example first forty-eight chips or sixty-four chips of each one of the selected for example six code signals are slided through the entire subframe of for example 6048 chips, and the computational complexity keeps its lower level, etc.

Finally, for example in case of the code length of for example sixty-four chips having been reached, or for example in case of one correlation result being extremely well, the best correlation result is now compared with a final threshold like for example the average signal strength of the input signal during the subframe.

The invention is based upon an insight, inter alia, that one big problem, which is difficult to solve, can be cut into many smaller problems, which are easier to solve, and is based upon a basic idea, inter alia, that a number of very precise calculations can be converted into an iteration comprising a number of rough calculations followed by one or more reduced numbers of more precise calculations.

The invention solves the problem, inter alia, of providing a correlation system, which reduces the computational complexity defined above.

Said comparator/selector 5 compares the correlation results and informs controller 3 via connection 6, which controller 3 in dependence of comparison results adapts said correlation parameters and said thresholds via control connection 9, and selects in response to comparison results a reduced number of code signals to be used for next correlations. Said comparator/selector 5 may select those code signals to be used for next correlations as well as may select the size of the reduction, both generally in dependence of comparison results and possibly in dependence of control information originating from controller 3 via control connection 9, and informs controller 3 via connection 6.

Said invention can be further improved by letting comparator/selector 5 further select, per certain code signal, those time-intervals of a subframe which are most promising (which give the best correlation results), and by informing controller 3 of these time-intervals. Generally this should be done by firstly individually processing each digital signal or each subgroup of digital signals of each group of digital signals—which group for example corresponds with one sequence—by for example comparing the results within each sequence with each other and/or with thresholds etc. Secondly the results of all sequences should be processed, like for example comparing these results with each other and/or with thresholds etc. In response to this information, controller 3 should control said correlators such that, per certain code signal, just these time-intervals are used for next correlations, which will further reduce the computational complexity.

Each block shown or not shown, can be 100% hardware, 100% software or a mixture of both. Each block shown or not shown can be integrated with each other block shown and/or not shown. Especially comparator/selector 5 and controller 3 will generally be integrated with each other due to both being realizable via a processor/memory. Correlators 10-41 can be realized through their own processors/memories (parallelly) or through one processor/memory destined for performing all correlations (parallelly and/or serially). Receiver 2 will generally comprise a mixer and a demodulator, and may further comprise a switch, a buffer, a duplexer, an A/D converter, and may form part of a transceiver, with a transmitting part being not shown in FIG. 1. Said input signal is generated each subframe (twice per frame), and then possibly stored/buffered (partly or entirely) to give correlation system 4, comparator/selector 5 and controller 3 sufficient time for the processing.

The selection by comparator/selector 5 of the second number (for example twelve) of correlators (of code signals) from a first number (for example thirty-two) of correlators (of code signals) can be made dependent upon the correlation results, for example under control of controller 3. And the starting with the first part (first length) of each code signal as well as the increase of this first part (first length) of each selected code signal to the second part (second length) can be made dependent upon the correlation results, for example under control of controller 3.

In the flow chart shown in FIG. 2 for elucidating a method according to the invention and a processor program product according to the invention, the following blocks have the following meaning:

Block 100: Start; go to 101;

Block 101: Reduce the code length of each code signal to the first length for each one of the first number of code signals; go to 102;

Block 102: Correlate the input signal with said previously defined code signals; go to 104;

Block 104: Is the length of the code signals equal to said code length? If yes, go to 105, if no, go to 103;

Block 103: Reduce said first number of code signals to the second number of code signals, and for each one of these second number of code signals increase the first length to the second length; go to 102;

Block 105: Calculate a final threshold and select one code signal having the best correlation result; go to 106;

Block 106: Is this best correlation result better than said final threshold ? If yes, go to 107, if no, go to 101;

Block 107: Stop.

The method according to the invention for correlating an input signal with a number of code signals each having a code length is characterized in that said method comprises the steps of performing iterative correlations and of adapting at least one correlation parameter per iterative correlation. And the processor program product according to the invention for correlating an input signal with a number of code signals each having a code length is characterized in that said processor program product comprises the functions of performing iterative correlations and of adapting at least one correlation parameter per iterative correlation. Said steps and functions are for example as follows:

A first step/function comprises the starting of said method/processor program product (Block 100). Then, a second step/function involves the reducing of the code length of each code signal to the first length for each one of the first number of code signals (Block 101). A third step/function comprises the defines the correlation of the input signal with said previously defined code signals (Block 102). A fourth step/function involves the checking whether the length of the code signals is equal to said code length (Block 104). If no, a fourth step/function comprises the reduction of said first number of code signals to the second number of code signals, and for each one of these second number of code signals the increase of the first length to the second length (Block 103), which is followed by said third step/function, but now with updated information, etc. If yes, a next step/function involves the calculation of a final threshold and the selection of one code signal having the best correlation result (Block 105). Then, a following step/function comprises the checking whether this best correlation result is better than said final threshold (Block 106). If no, this is followed by said second step/function, but now possibly with updated information (like for example with updated initial parameters, with the mobile terminal starting the cell searching once again). If yes, this is followed by a final step/function comprising the ending of said method/processor program product (Block 107).

Of course, further steps/functions are not to be excluded, like for example a counting step/function for counting the number of loops made to avoid the infinite looping, and like for example the comparison of (sequences of) digital signals (resulting from the correlations) with each other and/or with thresholds, and like for example the updating of thresholds, and like for example the selection of those code signals which are most promising and/or of the size of the reduction of said number of code signals to be used for next correlations and/or of the time-intervals to be used for next correlations instead of the entire subframe etc.

1. Correlation system (4) for correlating an input signal with a number of code signals each having a code length, characterized in that said correlation system (4) comprises a controller (3) for controlling said correlation system (4) for performing iterative correlations and for adapting at least one correlation parameter per iterative correlation.

2. Correlation system (4) according to claim 1, characterized in that a first correlation parameter corresponds with the length of code signals, with first correlations using code signals each having a first length smaller than said code length, and with next correlations using code signals each having a second length larger than said first length and smaller than or equal to said code length.

3. Correlation system (4) according to claim 2, characterized in that a second correlation parameter corresponds with the number of code signals, with first correlations using a first number of code signals, and with next correlations using a second number of code signals smaller than said first number of code signals.

4. Correlation system (4) according to claim 3, characterized in that said controller (3) is coupled to a comparator (5) for comparing correlation results for in dependence of comparison results adapting said at least one correlation parameter.

5. Correlation system (4) according to claim 4, characterized in that said controller (3) is coupled to a selector (5) for in response to comparison results selecting a reduced number of code signals to be used for next correlations.

6. Mobile terminal (1) for searching cells identified by code signals, which mobile terminal (1) comprises a receiver (2) for receiving a radio signal comprising at least one code signal and for converting said radio signal into an input signal and comprises a correlation system (4) coupled to said receiver (2) for correlating said input signal with a number of said code signals each having a code length, characterized in that said correlation system (4) comprises a controller (3) for controlling said correlation system (4) for performing iterative correlations and for adapting at least one correlation parameter per iterative correlation.

7. Mobile terminal (1) according to claim 6, characterized in that a first correlation parameter corresponds with the length of code signals, with first correlations using code signals each having a first length smaller than said code length, and with next correlations using code signals each having a second length larger than said first length and smaller than or equal to said code length.

8. Mobile terminal (1) according to claim 7, characterized in that a second correlation parameter corresponds with the number of code signals, with first correlations using a first number of code signals, and with next correlations using a second number of code signals smaller than said first number of code signals.

9. Mobile terminal (1) according to claim 8, characterized in that said controller (3) is coupled to a comparator (5) for comparing correlation results for in dependence of comparison results adapting said at least one correlation parameter until at least one cell has been found through identification of at least one code signal.

10. Mobile terminal (1) according to claim 9, characterized in that said controller (3) is coupled to a selector (5) for in response to comparison results selecting a reduced number of code signals to be used for next correlations until at least one cell has been found through identification of at least one code signal.

11. Method for correlating an input signal with a number of code signals each having a code length, characterized in that said method comprises the steps of performing iterative correlations and of adapting at least one correlation parameter per iterative correlation.

12. Processor program product for correlating an input signal with a number of code signals each having a code length, characterized in that said processor program product comprises the functions of performing iterative correlations and of adapting at least one correlation parameter per iterative correlation.

13. Method for searching cells identified by code signals, which method comprises the steps of receiving a radio signal comprising at least one code signal and of converting said radio signal into an input signal and of correlating said input signal with a number of said code signals each having a code length, characterized in that said method comprises the steps of performing iterative correlations and of adapting at least one correlation parameter per iterative correlation.
